(19) United States
(12) Patent Application Publication
(10) Pub. No.: US 2014/0016847 A1
(43) Pub. Date: Jan. 16, 2014

(54) MULTI-PHASE COMPUTED TOMOGRAPHY IMAGE RECONSTRUCTION

(71) Applicants: Brian Edward Nett, Madison, WI (US); Jed Douglas Pack, Glenville, NY (US); Kai Zeng, Rexford, NY (US)

(72) Inventors: Brian Edward Nett, Madison, WI (US); Jed Douglas Pack, Glenville, NY (US); Kai Zeng, Rexford, NY (US)

(73) Assignee: GENERAL ELECTRIC COMPANY, Schenectady, NY (US)

(21) Appl. No.: 13/549,138

(22) Filed: Jul. 13, 2012

(51) Int. Cl. G06K 9/00

(52) U.S. Cl. 382/131

(57) ABSTRACT

Approaches for reconstructing multi-phase images are disclosed. In certain embodiments, calibrated X-ray projection data acquired over at least a partial axial or low-pitch helical rotation is accessed and used to reconstruct one or more initial images. A frequency transform is performed on the images to generate respective frequency domain representations. Elements of the frequency domain representations are weighted based on at least the difference between the phase associated with the elements and a specified phase of interest. The weighted frequency domain representations are combined to generate a frequency domain representation at the phase of interest, which can be used to generate an image at the phase of interest.

### BACKGROUND

Non-invasive imaging technologies allow images of the internal structures of a patient or object to be obtained without performing an invasive procedure on the patient or object. In particular, technologies such as computed tomography (CT) use various physical principles, such as the differential transmission of X-rays through the target volume, to acquire image data and to construct tomographic images (e.g., three-dimensional representations of the interior of the human body or of other imaged structures). However, various physical limitations or constraints on acquisition may result in artifacts or other imperfections in the reconstructed image.

For example, in certain dynamic imaging contexts, such as cardiac imaging, it may be desirable to generate images corresponding to different phases of motion for the object or organ of interest (such as corresponding to different phases of the cardiac cycle). However, in general, it is difficult to provide useful phase selection (such as of a cardiac phase of interest) to a reviewer of the image data. Further, if very small increments of phase selection are desired, the needed storage increases substantially.

### BRIEF DESCRIPTION

In one embodiment, a method of reconstructing multi-phase images is provided. In accordance with this method, a set of calibrated X-ray projection data acquired over at least a partial rotation is accessed. A plurality of initial images is reconstructed at different phases based on the set of calibrated X-ray projection data. A frequency transform is performed on each initial image to generate a frequency domain representation of the respective initial image. For each frequency element of the frequency domain representation: a corresponding phase of the respective frequency element is determined and the frequency element is weighted based on the difference between the determined phase of the frequency element and a specified phase of interest to produce a weighted frequency domain representation. The plurality of weighted frequency domain representations are combined to produce a frequency domain representation corresponding to a phase window centered on the selected phase of interest. An inverse frequency transform is performed on the frequency domain representation at the specified phase of interest to produce a final image at the specified phase on interest.

In a further embodiment, one or more non-transitory computer-readable media are provided. The computer-readable media encode one or more routines which, when executed by a processor, cause the processor to perform acts comprising: accessing a set of calibrated X-ray projection data acquired over at least a partial rotation; reconstructing a plurality of initial images at different phases based on the set of calibrated X-ray projection data; performing a frequency transform on each initial image to generate a frequency domain representation of the respective initial image; for each frequency element of the frequency domain representation: determining a corresponding phase of the respective frequency element and weighting the frequency element based on the difference between the determined phase of the frequency element and a specified phase of interest to produce a weighted frequency domain representation; combining the plurality of weighted frequency domain representations to produce a frequency domain representation corresponding to a phase window centered on the selected phase of interest; and performing an inverse frequency transform on the frequency domain representation at the specified phase of interest to produce a final image at the specified phase on interest.

In an additional embodiment, an image processing system is provided. The image processing system comprises a memory storing one or more routines and a processing component configured to execute the one or more routines stored the memory. The one or more routines, when executed by the processing component: access a set of calibrated X-ray projection data acquired over at least a partial rotation; reconstruct a plurality of initial images at different phases based on the set of calibrated X-ray projection data; perform a frequency transform on each initial image to generate a frequency domain representation of the respective initial image; for each frequency element of the frequency domain representation: determine a corresponding phase of the respective frequency element and weight the frequency element based on the difference between the determined phase of the frequency element and a specified phase of interest to produce a weighted frequency domain representation; combining the plurality of weighted frequency domain representations to produce a frequency domain representation corresponding to a phase window centered on the selected phase of interest; and perform an inverse frequency transform on the frequency domain representation at the specified phase of interest to produce a final image at the specified phase on interest.

### BRIEF DESCRIPTION OF THE DRAWINGS

These and other features and aspects of embodiments of the present invention will become better understood when the following detailed description is read with reference to the accompanying drawings in which like characters represent like parts throughout the drawings, wherein:

FIG. 1 is a diagrammatical view of a CT imaging system for use in producing images in accordance with aspects of the present disclosure;

FIG. 2 depicts a representation of available data in the image domain obtained using a cone-beam CT system, in accordance with aspects of the present disclosure;

FIG. 3 depicts the sweep of a circle in frequency space to define a spherical shell;

FIG. 4 depicts a region swept out by a circle in frequency space over a 180 degree range for a point outside the scan plane such that frequencies are missing;

FIG. 5 depicts an alternative view of a region swept out by a circle in frequency space over a 180 degree range for a point outside the scan plane such that frequencies are missing;

FIG. 6 depicts a region swept out by a circle in frequency space over a 360 degree range;

FIG. 7 depicts a flowchart describing control logic steps for reconstructing an image, in accordance with aspects of the present disclosure; and

FIG. 8 depicts a flowchart describing control logic for reconstructing an image at an arbitrary phase of interest, in accordance with aspects of the present disclosure.

### DETAILED DESCRIPTION

In the context of dynamic image acquisition/reconstruction it may be useful to reconstruct images with different gating windows. For instance in the case of cardiac computed tomography (CT) these different gating windows correspond to different phases in the cardiac cycle. In cardiac CT imaging there is no a priori knowledge of the best phase for imaging each coronary artery. Therefore, clinicians often specify data to be collected over a range of cardiac phases. Typically, each image volume is reconstructed completely independently. For example, in clinical workflow phases are typically reconstructed at a limited number of discrete cardiac phases, such as every 5% or 10% in the R-R interval. In addition to diagnostic visualization, there may be other reasons to reconstruct multiple phases, such as Fourier Image Deblurring (FID) or Motion Evoked Artifact Deconvolution (MEAD). As discussed herein, an approach for reconstructing multiple image volumes with a significant time savings compared with brute force approaches is described.

In particular, as discussed herein one or more algorithms are described that are used to reconstruct multi-phase wide-cone images having suitable image quality and which do not introduce artifacts into the reconstructed images. Though multi-phase wide-cone image reconstruction is generally described by way of example herein, it should be appreciated that such examples are merely offered to facilitate explanation and are not intended to be limiting. Indeed, the algorithms and approaches discussed may be used in other dynamic imaging contexts and with other imaging protocols to generate phase-specific images as specified by a reviewer.

With this in mind, the examples described focus on the application of cardiac imaging, although the present approach may be applied to other tasks which generate multiple gated reconstructions that are offset in time. As will be appreciated, cardiac CT acquisitions may be made using either retrospective or prospective gating. In the case of a retrospective acquisition, projection data is acquired from all phases throughout the cardiac cycle. During the acquisition, the X-ray tube current may be modulated such that it is high during the portion of the cardiac cycle when the heart is generally most stationary. Conversely, in a prospective acquisition data is specifically acquired during only the desired portion of the cardiac cycle. However, a strict prospective acquisition does not provide flexibility in shifting the reconstructed phase. Therefore, in order to compromise between flexibility in cardiac phase reconstruction and minimal scan dose, additional scan data or padding data is often acquired. In the case of wide-cone data acquisition, a full-scan of data is typically acquired in order to generate adequate volumetric reconstructions. Therefore, in such a scan context, there is built-in phase padding due to the full-scan data acquisition.

With the foregoing in mind, embodiments disclosed herein provide algorithms for the reconstruction of phase-specific images from acquired data. For example, the algorithms provide for the construction of images at one or multiple phases corresponding to the motion of an imaged, dynamic object or organ. In practice this process, or its equivalent, may be accomplished in a computationally efficient manner, such as by using filtering steps where appropriate in one or both of the reconstruction space and/or the post-processing space.

The approaches disclosed herein may be suitable for use with a range of tomographic reconstruction systems. To facilitate explanation, the present disclosure will primarily discuss the present reconstruction approaches in the context of a CT system, such as using a cone-beam system, or a system employing an axial or helical scan protocol. However, it should be understood that the following discussion may also be applicable to other tomographic reconstruction systems.

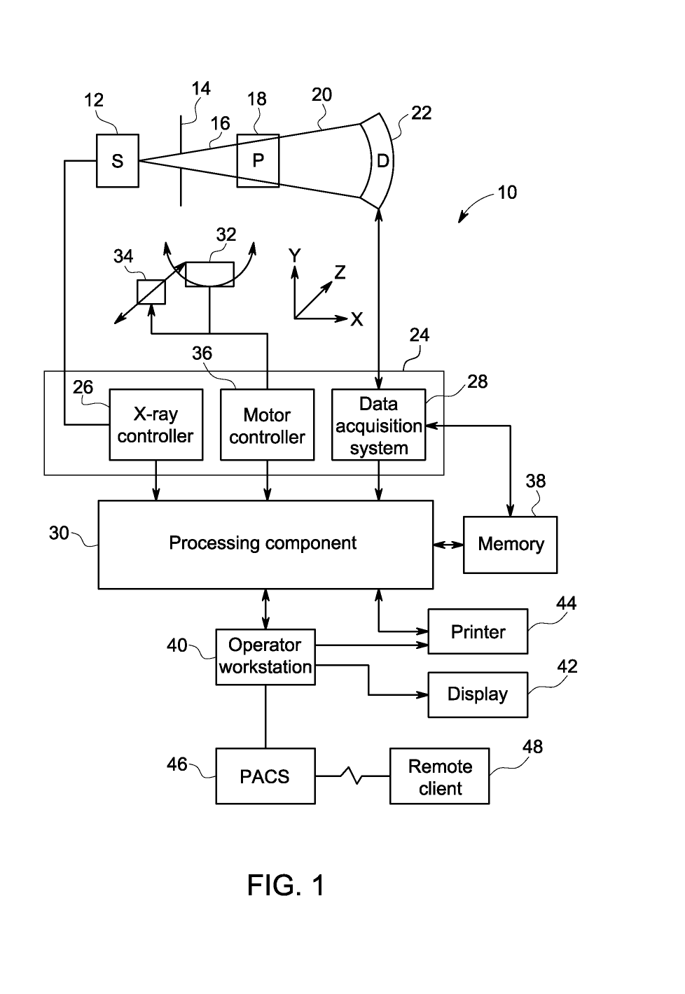

With this in mind, an example of a computer tomography (CT) imaging system 10 designed to acquire X-ray attenuation data at a variety of views around a patient (or other subject or object of interest) and suitable for tomographic reconstruction is provided in FIG. 1. In the embodiment illustrated in FIG. 1, imaging system 10 includes a source of X-ray radiation 12 positioned adjacent to a collimator 14. The X-ray source 12 may be an X-ray tube, a distributed X-ray source (such as a solid-state or thermionic X-ray source) or any other source of X-ray radiation suitable for the acquisition of medical or other images.

The collimator 14 permits X-rays 16 to pass into a region in which a patient 18, is positioned. In the depicted example, the X-rays 16 are collimated to be a cone-shaped beam, i.e., a cone-beam, that passes through the imaged volume. A portion of the X-ray radiation 20 passes through or around the patient 18 (or other subject of interest) and impacts a detector array, represented generally at reference numeral 22. Detector elements of the array produce electrical signals that represent the intensity of the incident X-rays 20. These signals are acquired and processed to reconstruct images of the features within the patient 18.

Source 12 is controlled by a system controller 24, which furnishes both power, and control signals for CT examination sequences. In the depicted embodiment, the system controller 24 controls the source 12 via an X-ray controller 26 which may be a component of the system controller 24. In such an embodiment, the X-ray controller 26 may be configured to provide power and timing signals to the X-ray source 12.

Moreover, the detector 22 is coupled to the system controller 24, which controls acquisition of the signals generated in the detector 22. In the depicted embodiment, the system controller 24 acquires the signals generated by the detector using a data acquisition system 28. The data acquisition system 28 receives data collected by readout electronics of the detector 22. The data acquisition system 28 may receive sampled analog signals from the detector 22 and convert the data to digital signals for subsequent processing by a processor 30 discussed below. Alternatively, in other embodiments the digital-to-analog conversion may be performed by circuitry provided on the detector 22 itself. The system controller 24 may also execute various signal processing and filtration functions with regard to the acquired image signals, such as for initial adjustment of dynamic ranges, interleaving of digital image data, and so forth.

In the embodiment illustrated in FIG. 1, system controller 24 is coupled to a rotational subsystem 32 and a linear positioning subsystem 34. The rotational subsystem 32 enables the X-ray source 12, collimator 14 and the detector 22 to be rotated one or multiple turns around the patient 18, such as rotated primarily in an x,y-plane about the patient. It should be noted that the rotational subsystem 32 might include a gantry upon which the respective X-ray emission and detection components are disposed. Thus, in such an embodiment, the system controller 24 may be utilized to operate the gantry.

The linear positioning subsystem 34 may enable the patient 18, or more specifically a table supporting the patient, to be displaced within the bore of the CT system 10, such as in the z-direction relative to rotation of the gantry. Thus, the table may be linearly moved (in a continuous or step-wise fashion) within the gantry to generate images of particular areas of the patient 18. In the depicted embodiment, the system controller 24 controls the movement of the rotational subsystem 32 and/or the linear positioning subsystem 34 via a motor controller 36.

In general, system controller 24 commands operation of the imaging system 10 (such as via the operation of the source 12, detector 22, and positioning systems described above) to execute examination protocols and to process acquired data. For example, the system controller 24, via the systems and controllers noted above, may rotate a gantry supporting the source 12 and detector 22 about a subject of interest so that X-ray attenuation data may be obtained at a variety of views relative to the subject. In the present context, system controller 24 may also includes signal processing circuitry, associated memory circuitry for storing programs and routines executed by the computer (such as routines for executing image processing techniques described herein), as well as configuration parameters, image data, and so forth.

In the depicted embodiment, the image signals acquired and processed by the system controller 24 are provided to a processing component 30 for reconstruction of images. The processing component 30 may be one or more conventional microprocessors. The data collected by the data acquisition system 28 may be transmitted to the processing component 30 directly or after storage in a memory 38. Any type of memory suitable for storing data might be utilized by such an exemplary system 10. For example, the memory 38 may include one or more optical, magnetic, and/or solid state memory storage structures. Moreover, the memory 38 may be located at the acquisition system site and/or may include remote storage devices for storing data, processing parameters, and/or routines for image reconstruction, as described below.

The processing component 30 may be configured to receive commands and scanning parameters from an operator via an operator workstation 40, typically equipped with a keyboard and/or other input devices. An operator may control the system 10 via the operator workstation 40. Thus, the operator may observe the reconstructed images and/or otherwise operate the system 10 using the operator workstation 40. For example, a display 42 coupled to the operator workstation 40 may be utilized to observe the reconstructed images and to control imaging. Additionally, the images may also be printed by a printer 44 which may be coupled to the operator workstation 40.

Further, the processing component 30 and operator workstation 40 may be coupled to other output devices, which may include standard or special purpose computer monitors and associated processing circuitry. One or more operator workstations 40 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

It should be further noted that the operator workstation 40 may also be coupled to a picture archiving and communications system (PACS) 46. PACS 46 may in turn be coupled to a remote client 48, radiology department information system (RIS), hospital information system (HIS) or to an internal or external network, so that others at different locations may gain access to the raw or processed image data.

While the preceding discussion has treated the various exemplary components of the imaging system 10 separately, these various components may be provided within a common platform or in interconnected platforms. For example, the processing component 30, memory 38, and operator workstation 40 may be provided collectively as a general or special purpose computer or workstation configured to operate in accordance with the aspects of the present disclosure. In such embodiments, the general or special purpose computer may be provided as a separate component with respect to the data acquisition components of the system 10 or may be provided in a common platform with such components. Likewise, the system controller 24 may be provided as part of such a computer or workstation or as part of a separate system dedicated to image acquisition.

As noted above, the reconstruction of phase-specific images from data acquired by an imaging system, such as the depicted CT imaging system 10, may be subject to various limitations that may result in artifacts or other imperfections in the generated images. For example, the acquired data may be truncated in the z-direction in certain acquisition scenarios. In particular, in an axial (i.e., circular) or low-pitch helical cone-beam acquisition, certain of the voxels in the image volume will always be in the X-ray beam during a rotation of the source 12 about the imaged volume (such as those voxels near a mid-plane i.e., plane in which the X-ray focal spot moves) while other voxels are illuminated in certain of the views during the rotation but not in others. For example, due to the narrow portion of the X-ray cone being closer to the X-ray source 12, (that is, the cone expands or diverges as distance from the source increases) a narrow segment of voxels near the X-ray 12 source may be illuminated while those voxels furthest from the source are fully or mostly illuminated due to being near the wide base of the cone. However, as the X-ray source is rotated about the volume, the portions of the volume that are near and far from the X-ray source 12 will also rotate, with the result being that the extent of X-ray illumination a voxel receives may decay monotonically with distance of the voxel from the mid-plane of focal spot rotation. As a result, there is less data available with respect to the edges of the X-ray cone in the z-direction in an axial or low-pitch helical scan than for those voxels nearer the mid-plane of the cone in the z-direction.

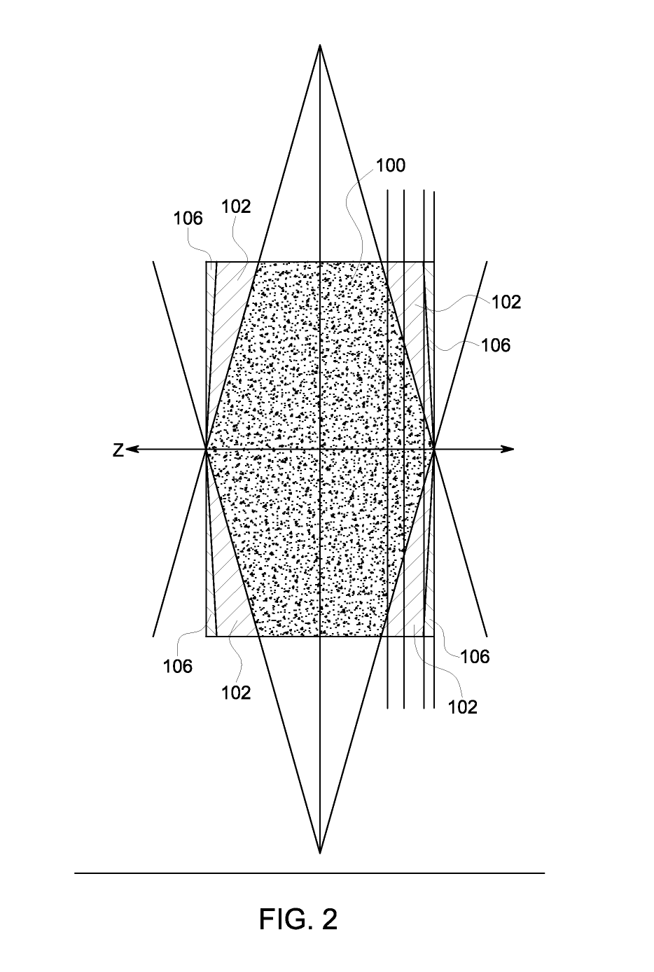

By way of example, in an axial scan of a cone-beam CT scanner, not all voxels are within the X-ray cone from all view angles due to the limited z-extent of the detector. This data truncation in the z-direction may prevent the reconstruction of good quality images outside that portion of the volume which is always projected onto the detector during an axial scan. Turning to FIG. 2, for an axial full-scan (i.e., a 360 degree axial rotation of the X-ray source and detector), region 100 is seen for the full 360 angular range. That is, for an axial full-scan region 100 provides 360 degrees of data. For an axial half-scan (i.e., a 180 degree+α rotation of the X-ray source and detector), region 100 yields at least 180 degree of data (but less than 360 degrees of data). For region 100, there is no z-truncation problem, though there may still be issues related to missing frequencies and/or mishandled data.

For region 102, an axial full-scan provides less than 360 degrees of data but more than 180 degrees of data. For an axial half-scan, region 102 provides less than 180 degrees of data. Thus, there may be substantial missing data in region 102 in the half-scan scenario and, even in the full-scan scenario the data is less than complete. Region 106 represents those voxels for which less than 180 degrees of data is measured regardless of whether a full-scan or a partial or half-scan is performed. As a result, image quality close to the edge slices will typically be poor, with strong streaks may be observed along the tangent direction.

With the foregoing data completeness scenarios in mind, any given voxel may be seen by the source and detector for a certain angular view range in a given cone-beam axial scan. However, some Radon directions or frequencies will be measured twice in such a scan. The reconstruction process should correctly take into account this redundancy or artifacts may result. In certain instances, mishandled data may result in cone-beam artifacts in the reconstructed image.

In addition, in some instances where a cone-beam axial scan is employed, certain frequency information may be missing for a given voxel. For example, even inside the 360 degree region generated by a circular (i.e., axial) scan, there may be some missing frequencies, particularly along the z-direction. The amount of missing frequencies will increase with distance from the mid-plane (plane in which the x-ray focal spot moves).

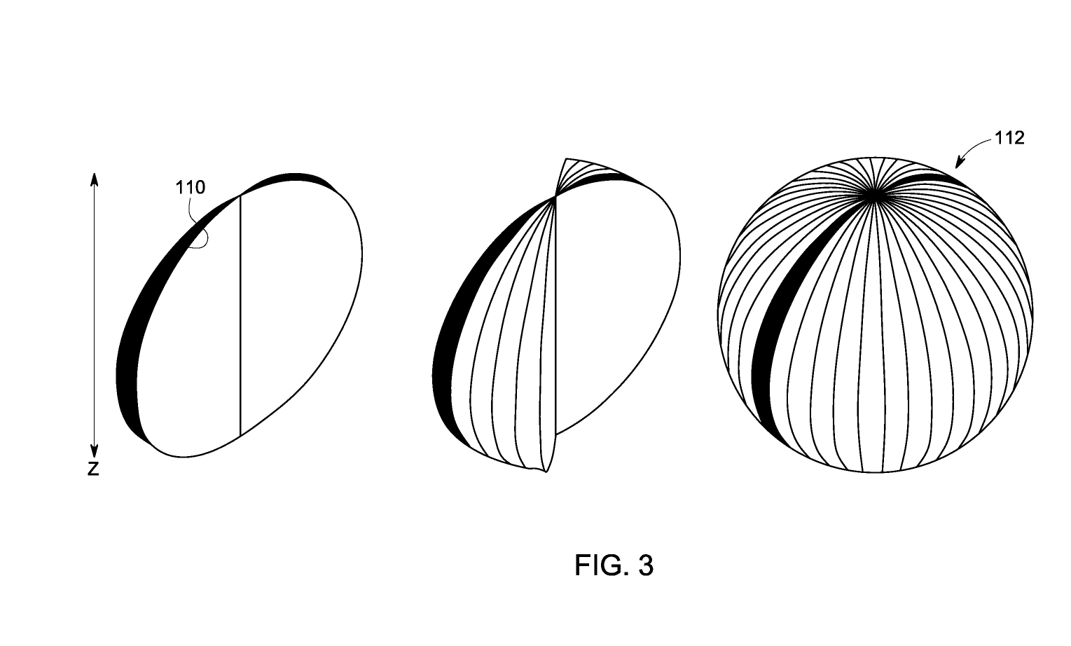

In terms of visualizing these data completeness concepts at the voxel level, FIGS. 3-6 depict aspects of frequency analysis that may prove useful to understanding the present approach. In particular, in cone-beam tomography each measured (and filtered) ray contributes 3D Radon (or Fourier) information (i.e., frequency information) in a great circle (or disk in the Fourier case) that is orthogonal to the ray. In order to get an exact reconstruction at a particular voxel, filtered rays are accumulated whose frequency contributions cover the frequency sphere uniformly. If a ray has cone angle zero, its corresponding great circle in frequency space is parallel to the z (frequency) direction. Such is the case for points that lie in the plane of the source trajectory (the scan plane). Thus, in order to get an exact reconstruction at a particular voxel in the scan plane, filtered rays should be accumulated that pass through the voxel over a 180 degree range relative to or as seen by that voxel. This can be appreciated by noting that the vertical (parallel to z) circle 110 depicted will sweep out an entire spherical shell 112 as it is rotated 180 degrees, as shown in FIG. 3.

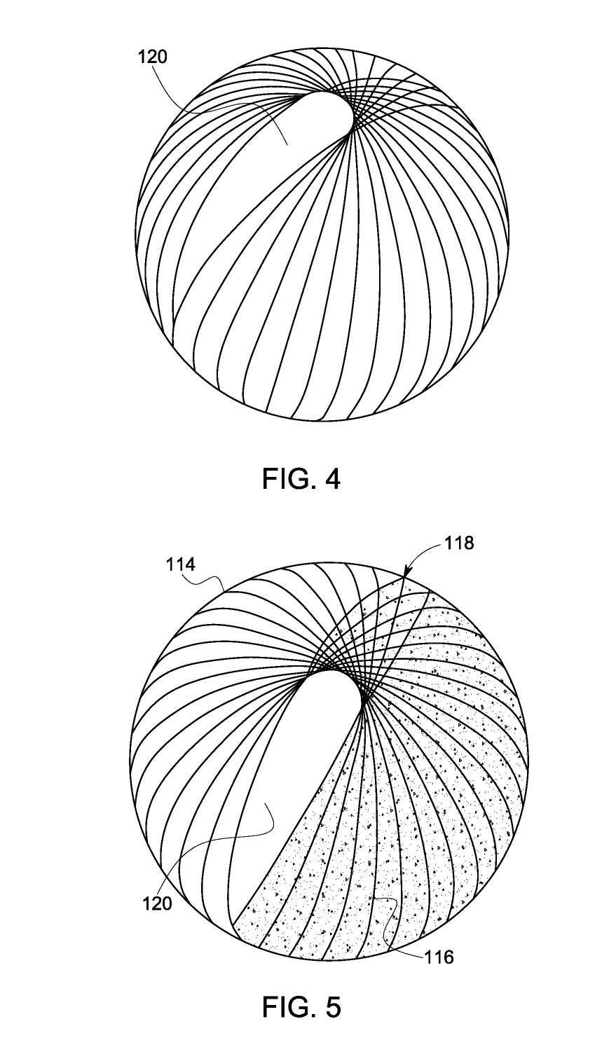

For points that lie outside the scan plane, the great circle 110 is tilted off of the z-axis by the cone angle. If such data is used over a 180 degree range, the result appears as depicted in FIGS. 4 and 5. In FIG. 5, the region swept out by the two halves of each great circle is depicted with different hatching (first hatching 114 and second hatching 116) to facilitate visualization. There is a region of the sphere that is covered twice (combined hatching 118) and another region that is not covered at all (missing frequency information 120).

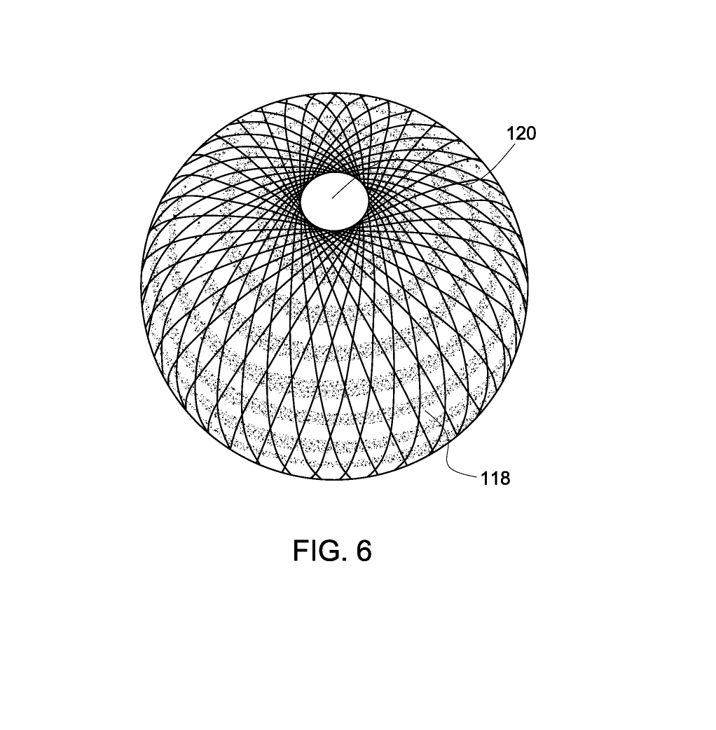

If this is continued for 360 degrees instead of just 180 degrees, the result appears as depicted in FIG. 6. As depicted in FIG. 6, all frequencies are measured twice (denoted by combined hatching 118) except for those that are not measured at all (missing frequency information 120), as indicated by the gap at the top of the unit sphere.

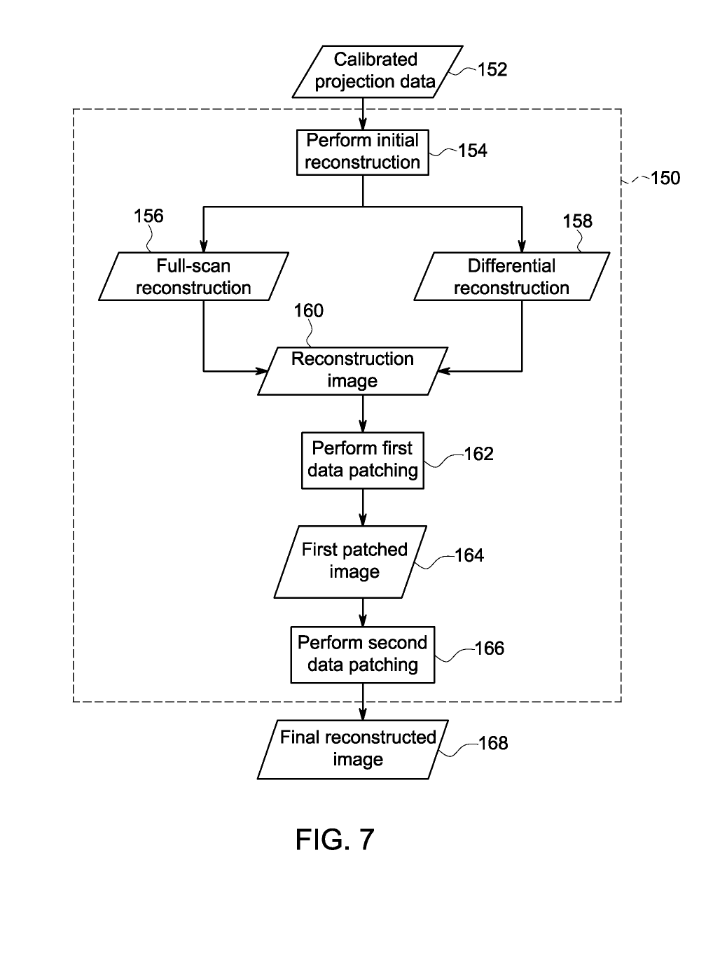

With the foregoing discussion in mind, the present approaches can include addressing one or more of these data completeness issues in conjunction with allowing reconstruction of one or more phase-specific images corresponding to gated reconstructions that are offset in time. As used herein, the term “phase” is employed to simplify explanation with respect to certain implementations, such as cardiac implementations. However, the present approach may be equally applicable to implementations where the imaged volume does not undergo periodic or repetitive motion. Thus, as used herein the term “phase” should be understood to encompass data acquired or corresponding to a point or interval of time or to a particular motion state, regardless of whether the motion is periodic or not. In certain implementations, a series of reconstruction steps or algorithms are employed to generate images. By way of example, and turning to FIG. 7, in a generalized base scenario where a single image is to be reconstructed and no particular phase (φ) is specified, a reconstruction algorithm 150 may include a number of sub-algorithms, each addressing different data completeness issues noted above.

For example, as depicted in FIG. 7, a set of calibrated projections 152 (such as projections acquired by at least a partial rotation, axial or low-pitch helical scan of a cone-beam CT system) is acquired or otherwise accessed. In one embodiment, the acquired projections 152 undergo a first reconstruction step 154 comprising projection filtering and backprojection to, in effect, recombine acquired data so as to generate a substantially uniform and complete set of frequency data where frequency data might otherwise be incomplete. This process, or its equivalent, may be accomplished in a computationally efficient manner using filtering steps in one or both of the reconstruction space and/or the post-processing space.

For example, in one implementation, eight (or some other number, such as ten, twelve, sixteen, twenty sectors and so forth) sectors of acquired projection data are backprojected. The data is split after rebinning so that each segment contributes 45 degrees (or some other extent, i.e., for twenty sectors 18 degrees are contributed per segment) of Fourier (i.e., frequency) information regardless of which image voxel one considers. As will be appreciated, the cone angles (and, hence, the amount of tilt between the various great circles and the z-axis) changes with the view angle whenever the voxel under consideration is away from the center of the FOV in (x,y).

In one such implementation an algorithm may be employed in which an initial set of axial half-scan (or less than full-scan) data is initially reconstructed from a 180 degree view range to generate an image. The image is filtered to select only frequencies from a 45 degree range, thereby generating a partial reconstruction. In one embodiment, this process is repeated (at shifted view ranges) a set number of times, such as four times at view ranges that are shifted by 45 degrees each time. In such an embodiment, if the steps have been performed the specified number of times, the partial reconstructions generated in this manner can be combined to generate a dataset with uniform and complete frequency data. If the specified number of iterations have not occurred, the view range is shifted, such as 45 degrees, and the next image is reconstructed.

In one implementation, the process may be repeated through another cycle, e.g., another four times in this example. As will be appreciated in this example, the partial reconstructions that use the same filter in each cycle may be paired and the 180 degree view ranges for each of these pairs of partial reconstructions are complementary (i.e.: diametrically opposed). As a result, the union of the two view ranges is the entire 360 degree view range. Since reconstruction and filtering are linear operations, the same result may be obtained by applying the filter that corresponds to a selected pair of partial reconstructions to a full-scan reconstruction as you would by applying this filter to the two 180 degree reconstructions and then adding the two together. Furthermore, since the four filters sum to one at every frequency, the net result of all eight partial reconstructions is equal to a full-scan reconstruction.

With this in mind, it may be appreciated that: (1) there are two contributions to each frequency from a full-scan reconstruction, or, equivalently, from eight of the partial reconstructions described above, and (2) four partial reconstructions give a result that selects at almost every frequency the contribution from the view that is closer to a given view angle. With this in mind, one set of the complementary partial reconstructions retain at almost every frequency only the contribution from the view that is farther from the given view angle. Also, selecting the view that is farther from a selected view is equivalent to selecting the view that is closer to a different view, specifically, the view that is 180 degrees away from the selected view.

With the foregoing in mind, one implementation of the present initial reconstruction algorithm produces two separate intermediate volumes. The first intermediate volume is the result of the first set of partial reconstructions and the second intermediate volume is the result of the second set of partial reconstructions. As will be appreciated, the view ranges that contribute the most to one partial reconstruction contribute very little, if any, to the other. Indeed, no point (frequency) is filled by the same view range in the two complementary reconstructions. The two reconstructions are predominantly built from data in two opposing 180-degree view ranges of the full-scan.

As discussed herein, the two intermediate reconstructions can be mixed together via filtering (such as via a filter and complementary filter) in the frequency space to produce a composite reconstruction that is predominantly built from an arbitrary (e.g., user selected) 180-degree view range. In one such example, 90-degree sectors of each intermediate reconstruction may be combined to produce a composite reconstruction that predominantly uses data from a 180-degree range with a center-view exactly in the middle of the center-views corresponding to the intermediate reconstructions. Of note is that the central segment in the composite reconstruction corresponds to frequencies of the view portion that are 90 degrees offset from the respective view portions corresponding to the frequencies that correspond to the central views of the intermediate reconstructions.

In other examples, the centerview of the composite reconstruction may be shifted to other extents. For example, in one implementation the centerview of the composite reconstruction is shifted 45 degrees relative to the first of the two intermediate reconstructions. As will be appreciated, the offset need not be an increment of 45 degrees. In such implementations, the look of the frequency space differs from the previous example, but the result is the same: the frequency contribution that is closest to the chosen centerview is selected.

As will be appreciated from the above examples and discussion, and as further discussed below, one can efficiently generate a variety of reconstructions each with a different cardiac phase from a single pair of intermediate reconstructions. Thus, a time series of the cardiac motion can be generated efficiently as a post-processing step. Even if more than a single rotation of data is acquired, one intermediate reconstruction can be generated for each 180-degree view range and an image representing any cardiac phase (that is sufficiently within the acquisition window) can be generated, as discussed below.

The preceding discussion relates to an example in which 360 degrees of data is available. However, as discussed above, it should be appreciated that even if 360 degrees of cone-beam data is acquired, some portions of the reconstruction volume may not be measured (project onto the detector) for the full set of views. That is, some portion of the reconstruction volume is measured at all views, while the remainder of the reconstruction volume is not measured at all views.

With respect to the portion of the reconstruction volume that is not measured at all views, in these regions, extrapolated data may be used to fill in some regions of frequency space. The result is that the intermediate reconstructions may include artifacts. Since different parts of the volume project onto the detector for different view ranges, the frequency content of the artifacts is spatially variant. Indeed, there will be a certain sector (opposite the centerview) of each axial image in the corner region that is least affected by the truncation artifacts in each of the two intermediate reconstructions. By applying the Fourier mixing discussed above, this polar angle can be changed to any direction.

This observation may be employed as part of the present sub-algorithm reconstruction step 154 to mitigate truncation artifacts. For example, in one such embodiment, the portion of the reconstruction volume that is not measured at all views is segmented into multiple sectors. For each sector, Fourier mixing as discussed above may be applied to produce an image that consists mostly of the half-scan that is centered at the view opposite the selected sector. The result will be an image that has minimal artifacts in the sector of interest. The minimal artifact sector of each resulting image can then be combined. The Fourier mask that is used in the Fourier mixing step may also employ some degree of smoothing. In implementations where different forms of smoothing are employed, the combination of the two smoothing operations may effectively provide a suitable view weighting function for each voxel in the image.

In the preceding discussion, the formation of the two intermediate reconstructions has been attributed to performing two sets of four separate 180 degree reconstructions (or some other number and extent of reconstructions) followed by applying Fourier masking to each of the eight reconstructions before combining each set of four into a single image. While such an implementation is useful as a means for explaining the present algorithm and for deriving the algorithm, in other embodiments, the present reconstruction algorithm may be implemented differently to achieve a more computationally efficient outcome.

For example, in an alternative implementation (depicted in FIG. 7), instead of generating and storing intermediate reconstructions that are representative of two different halves of the full-scan, a reconstruction 156 that represents the full-scan and a reconstruction 158 that represents the difference of the two halves of the full-scan, i.e., the differential, can be generated and used. The full-scan reconstruction 156 and the differential reconstruction 158 can be combined to generate one or more reconstructions 160 of interest for a given phase.

While the initial reconstruction step 154 addresses certain of the data and frequency deficiencies noted with respect to the projection data 152, other deficiencies may be unaddressed and may result in artifacts. For example, the above noted initial reconstruction step 154 may not address artifacts attributable to z-truncation in axial cone-beam CT reconstruction, i.e. to reconstruct voxels from data with some missing views. In particular, voxels close to the edge slices may have very limited data, i.e., even less than 180 degree of data (e.g., region 106 in FIG. 2). Therefore, extrapolation and image domain corrections may be employed to suppress artifacts. Traditionally, simple extrapolation is used in the projection domain, which makes the detector virtually bigger by replicating real data from the boundary row to virtual rows. However, this method may be unsuitable for objects that are not uniform in the z-direction, producing errors and streak artifacts.

By way of further example, in various implementations image data may be missing views in the edge slices due to the limited z coverage of the detector, hence, extrapolated views will be used during the reconstruction. These missing views in the image domain correspond to missing frequency data in the Fourier domain. The artifacts caused by these missing frequencies will have an associated direction. In accordance with one approach discussed herein, data may be generated and used in place of the missing frequencies, such as by execution of a suitable sub-algorithm, i.e., first data patching step 162.

In accordance with one implementation of such an first data patching algorithm, an initial set of measured axial projection data 152, such as may be acquired by using a cone-beam CT system, is reconstructed (block 154) to generate an initial reconstructed volume 156, as discussed above. In one implementation the volume 156 is reconstructed by back-projection. In one embodiment, z-extrapolation is employed to generate additional data in the z-direction beyond the detector edge. In one implementation, this z-extrapolation may simply extend the last measured value in z outward. This approach is suitable if the object in question is actually uniform in z beyond the edge of the detector 22. Alternatively, the extrapolation step may reproject a previously reconstructed volume, such as a volume that includes information about what lies beyond the edge of the detector 22.

In one implementation, a non-linear transformation step may be employed to generate a non-linear transformation (i.e., a cartoonized volume) that includes frequencies missing in the initial reconstructed volume 160. The non-linear transformation may be implemented as a binning process or other quantization process, as discussed below. The missing frequencies can be used to reduce or eliminate artifacts. The missing frequency region depends on the location of the voxel or voxels in question. Therefore, in one implementation, the patching process may be implemented as a shift-variant process. However, in other implementations where computational efficiency is a consideration, the images (i.e., reconstructed volumes) may be processed in pieces (i.e., region-by-region), and within each region a suitable space-invariant filter may be applied to patch in the missing frequencies for that region. In such an embodiment, a different space-invariant filter may be applied within each region though, if appropriate, some regions may employ the same space invariant filter.

With respect to the generation of the non-linear transformation, in one implementation recovery of missing data utilizes prior knowledge of the object being scanned. In the case of medical (and many other) CT images, this prior knowledge can include an assumption that the image is sparse in the histogram domain (i.e., that the true, i.e., artifact-free, image is dominated by voxels with values that are close to a small set of discrete values). For example, medical images typically include voxels having an intensity corresponding to air, water, lung, soft tissue, fat, and/or bone. Variations from this model that fall within the missing frequency region are likely artifacts.

The above observations suggest one mechanism for forming the non-linear transformation. In accordance with this approach, each voxel is categorized as either air, lung, soft tissue or bone. The intensities of each voxel are modified according to a set of rules for that tissue type. If the categorization of a given voxel is done strictly based on comparing the voxel intensity to a set of thresholds, the two steps (categorization and modification) can be combined into a single non-linear function.

For example, in one implementation of such a non-linear function, the Hounsfield (HU) values of the bone are left unchanged, i.e., this portion of the function may respond linearly. This is because the HU values of bone are much less uniform than the HU values of the other tissue types. Fortunately, bone tends to be a small percentage of the overall voxels so the impact of not having a stable intensity to assign to bone voxels is generally not too problematic. Unlike the values for bone, the values for voxels classified as water, fat, lung, or air may be set to defined values in one implementation of a non-linear function (i.e., these voxels are binned based on category and assigned a specified value based upon the binning process), though this may vary in other suitable functions.

With respect to artifacts in the images, the z-extrapolation method used in the back-projection step works well for objects that are uniform in z (i.e., for objects where the observed values at the edge really do extend beyond the edge in a uniform manner). For objects that are changing slowly in the z-direction, the artifacts may be small (i.e., the change from the observed or measured data is small and/or gradual in the z-direction). However, objects that are change strongly in the z-direction may create strong artifacts due to the failure of the observed data at the edge to properly account for the actual properties of the edge objects.

Another important aspect is the orientation of the high contrast objects generating the artifacts. For example, if an object's edges all fall within the measured region, no artifacts may result. However, if one or more of the edges of an object fall in the region where data is missing, artifacts may result. Thus, artifacts may appear when two conditions hold true: a gradient is present that has a z-component (i.e., a non-uniformity in z) and an x,y edge would be seen in one or more of the missing views. Based on these criteria, a set of artifact creating voxel locations can be identified. In one implementation, for identifying gradients with z-components, the non-linear transformation may be employed as this image may place more emphasis on the gradients associated with bony structures. For identifying x,y edges that would be seen in one or more of the missing views, it may be useful to use the initial reconstructed volume 160, which provides accurate gradient direction. In one implementation, x,y edges that would be seen in one or more of the missing views may be identified in accordance with the equation atan(Grad_{y}/Gradₓ).

Once the artifact-generating structures are identified an artifact mask may be generated which identifies the locations or regions that the artifact generating structures will impact. In one implementation an azimuthal smoothing operation is performed to approximate the possible artifact region on each two-dimensional image. The azimuthally blurred artifact-generating voxels are considered an estimation of the artifact region, i.e., the artifact mask. In certain embodiments where an artifact mask is employed, only those voxels within the artifact mask are processed or corrected in a Fourier blending operation.

In other implementations a 3D blurring operation may be employed to generate the artifact mask instead of a 2D azimuthal blurring operation. In particular, the artifact generating voxels are expected to generate artifacts in three-dimensional space rather than a two-dimensional slice. Therefore, a more accurate artifact mask could be computed in three-dimensions, including the spatial span of the artifacts and/or the magnitude of the artifact. This three-dimensional artifact information can be used to fine tune the generation of the non-linear transformation (such as to adapt a thresholding operation based on the local artifact level).

As noted above, the artifact mask defines the region or regions to be corrected and to protect other regions to prevent inadvertent alteration of image regions where no correction is needed. The rationale for employing the artifact mask is that even in the edge region where data is missing, a substantial portion of the image may not be contaminated by artifacts and therefore does not need correction.

After the artifact mask is generated, Fourier blending may be employed to blend in data (i.e., missing frequencies) from the non-linear transformation into the initial reconstructed volume 160 to generate first patched image 164. In the depicted implementation, the blending operation is performed only on those regions where frequency data is missing and only in the artifact mask regions. As will be appreciated, the Fourier patching process may, at the extreme be performed voxel-by-voxel, to account for the differences between voxels. However, in other embodiments, the process is performed slice by slice, sub-region by sub-region so a number of two-dimensional fast Fourier transforms (2D FFTs) and/or two-dimensional inverse fast Fourier transforms (2D IFFTs) may be performed.

While the preceding sets forth a framework for various approaches by which frequency data may be generated and used in place of frequency data otherwise missing from the measured image data, various speed and/or image quality enhancements may be implemented as part of these approaches. For example, in one implementation 2D parallel forward-projection, 1D ramp filtration, and 2D parallel back-projection (i.e., reprojection) of the difference of the non-linear transformation 252 and the initial reconstructed volumes 160 are used to replace 2D FFTs and IFFTs. In such an implementation, a voxel dependent weighted back-projector may be employed to handle the shift-variant nature of the patching step. In addition, Fourier-based techniques may be employed to implement fast forward-projection, ramp-filter and voxel dependent weighted back-projection algorithms.

Turning back to FIG. 7, a second data patching step 166 may be performed as well to address different data sufficiency issues and to generate a final reconstructed image 168. For example, while the first data patching step 162 addresses missing frequencies caused by missing views, such as due to data truncation issues, the second data patching step 166 may be employed to patch in data for polar frequencies that correspond to high frequencies along z and low frequencies along x-y and which correspond to the cone angle.

For example, in one embodiment, a reconstructed volume, such as reconstruction image 160 or first patched image 164, is generated, as discussed herein, or otherwise accessed. A threshold comparison step may be employed to generate a thresholded or simplified volume (i.e., a cartoonized volume). The simplified volume may include frequencies missing in the reconstructed volume 160, 164, which can be used to reduce or eliminate artifacts. In the depicted implementation, the simplified volume may be filtered (or otherwise processed) to extract the missing frequencies. The missing frequencies may be added to the reconstructed volume 160, 164 to generate the final reconstructed volume 168. In one embodiment, such as in the depicted example, a filter complementary to the filter applied to the simplified volume may be applied to the reconstructed volume 160, 164 to avoid duplicating some frequencies. In such an embodiment, the resulting filtered volume is combined with the missing frequencies to generate the final reconstructed image 168.

Thus, in such an embodiment, a thresholded or cartoonized volume (i.e., simplified volume) is generated and missing frequency data is extracted, e.g., filtered. The missing frequency data may then be added or otherwise combined with the initial reconstructed volume 160, 164 (or a filtered version of such a volume) to generate a final reconstructed volume 168 that includes the missing frequency data. The missing frequencies typically correspond to the “poles” of the centered, frequency domain sphere. That is, for a full circular scan, the missing frequencies fall within a double cone whose axis lies along the z-axis in frequency space. In an alternative implementation, the initial reconstructed volume 160, 164 is subtracted from the simplified volume to generate a difference volume. The missing frequencies may be extracted or otherwise selected from the difference volume (such as by a filtering step) and added to the initial reconstructed volume 160, 164 to generate the final reconstructed volume 168.

With respect to the generation of the simplified (i.e., “cartoonized) volume, in one implementation, recovery of missing data utilizes prior knowledge of the object being scanned, as discussed with respect to the first data patching step 162. In the case of medical (and many other) CT images, this prior knowledge can include an assumption that the image is sparse in the histogram domain (i.e., that the true, i.e., artifact-free, image is dominated by voxels with values that are close to a small set of discrete values). For example, as discussed above, medical images typically include voxels having an intensity corresponding to air, water, lung, soft tissue, fat, and/or bone. Variations from this model that fall within the missing frequency region are likely artifacts.

Thus, in accordance with one implementation, each voxel is categorized as one of air, lung, soft tissue or bone. The intensities of each voxel are modified according to a set of rules for that tissue type. If the categorization of a given voxel is done strictly based on comparing the voxel intensity to a set of thresholds, the two steps (categorization and modification) can be combined into a single non-linear function.

In one example of a non-linear function, the Hounsfield (HU) values of the bone voxels are left unchanged. This is because the HU values of bone are much less uniform than the HU values of the other tissue types. Fortunately, bone tends to be a small percentage of the overall voxels so the impact of not having a stable intensity to assign to bone voxels is generally not too problematic. Unlike the values for bone, the values for voxels classified as water, fat, lung, air, and so forth are set to defined values in one such example of a non-linear function, though this may vary in other suitable functions. Furthermore, if the artifact reduction of the present approach is insufficient, it can be applied multiple times (i.e., iterated). In this case, the initial reconstruction 160, 164 is still used to provide the non-missing frequencies, but the thresholding is applied to the latest image estimate.

As will be appreciated in the above discussion, the above approaches may be based on quantizing (such as by the above non-linear function) an initial reconstruction 160, 164 of an image and adding back into the reconstruction process frequencies introduced by the quantization process wherever there are frequencies missing in the original reconstruction 160, 164. As will be appreciated, other approaches to generating the missing frequencies may be employed than those discussed above. In particular, various non-linear operations may be employed to introduce otherwise missing frequencies, image quantization being only one example of such a process.

Examples of non-linear operations that may be employed to introduce the missing frequencies include, but are not limited to histogram binning, image compression, anisotropic diffusion, reconstruction from wavelet maxima, a total variation reduction step, and/or a segmentation step combined with assigning synthetic voxel values in each segmented region. With respect to these approaches, image quantization is merely one example of a type of histogram binning in which the bins are selected to be representative of values in the image range. However, histogram binning is a more general tool and it can be applied to purposes other than quantization. For example, histogram binning may be applied in the present context to perform histogram transformations yielding images with the desired properties in the distribution of image values.

As used herein, histogram binning may be understood, in its simplest form, to constitute one or more steps by which all voxel values in a volume within each of a number of value ranges are set to a certain pre-defined value within that range. For example, all voxels with a value less than or equal to 200 Hounsfeld units might be modified to be 0 HU. Similarly, all voxels with a value between 200 and 500 could be set to 300 HU and those voxels that are between 500 and 1400 could be set to 1000 HU. There are variations to histogram binning that may be employed. For example, transition regions can be introduced at bin boundaries such that the transfer function is not discontinuous. Also, the bin boundaries and even the number of bins can be changed from one iteration to the next. Also, the image can be smoothed after applying histogram binning.

With respect to the filtering steps discussed above, a suitable algorithm may accomplish the filtering in a number of different ways. For example in one implementation of an algorithm as discussed herein, the act of filtering may be performed as a shift-invariant operation. In other implementations, however, the act of filtering may be performed as a shift-variant operation.

In an alternative algorithm for addressing the missing frequency issue, high-contrast objects are segmented and extracted from a reconstructed volume 160, 164, i.e.,: either replaced by a pre-defined value, or a pre-defined value is subtracted. The remaining image only contains lower-contrast objects and artifacts (corresponding to z-frequencies). The z-frequencies (and therefore the artifacts) may be eliminated, such as by applying a suitable frequency mask, to generate a masked image in which z-frequency related artifacts are removed. Then the high-contrast objects are added to the masked image, resulting in the final reconstructed image 168.

Turning back to FIG. 7, the foregoing discussion describes the various steps and algorithms that may be employed in generating an initial reconstruction image 160 and addressing various data sufficiency or completeness issues (i.e., generating first patched image 164 and final reconstructed image 168).

The foregoing describes the various data patching steps that may be involved in a reconstruction process to address issues related to data sufficiency and/or completeness. Some or all of these data patching steps may be employed in generating a final image at an arbitrary phase, as discussed below. As discussed above, this initial reconstruction process may be performed using an iterative reconstruction algorithm, such as based on a threshold or model-based criterion that determines the completion of the iterative reconstruction processing.

As discussed herein, in the context of dynamic CT acquisition and/or reconstruction there is often the desire to reconstruct images with different gating windows. For instance in the case of cardiac CT these different gating windows correspond to different phases in the cardiac cycle. In cardiac CT imaging there is no a priori knowledge of the best phase for imaging each coronary artery. Therefore, clinicians often specify data to be collected over a range of cardiac phases. Typically, each image volume is reconstructed completely independently. In clinical workflow typically phases are reconstructed at a limited number of discrete cardiac phases, such as every 5% or 10% in the R-R interval.

With this in mind, real-time, wide-cone image reconstruction of an arbitrary cardiac (or other) phase is described and may incorporate algorithms or approaches discussed herein for addressing issues related to data sufficiency or completeness. In certain embodiments, initial reconstruction volumes are saved and combined using appropriately weighted summations in the Fourier domain to approximate analytic reconstruction of each phase. This allows a reviewer to scroll through the phases interactively and to select the optimal portion in the cardiac cycle to visualize each portion of the anatomy. In one implementation the need for backprojection may be eliminated for the real-time reconstruction, allowing the approach to take advantage of fast Fourier transform techniques.

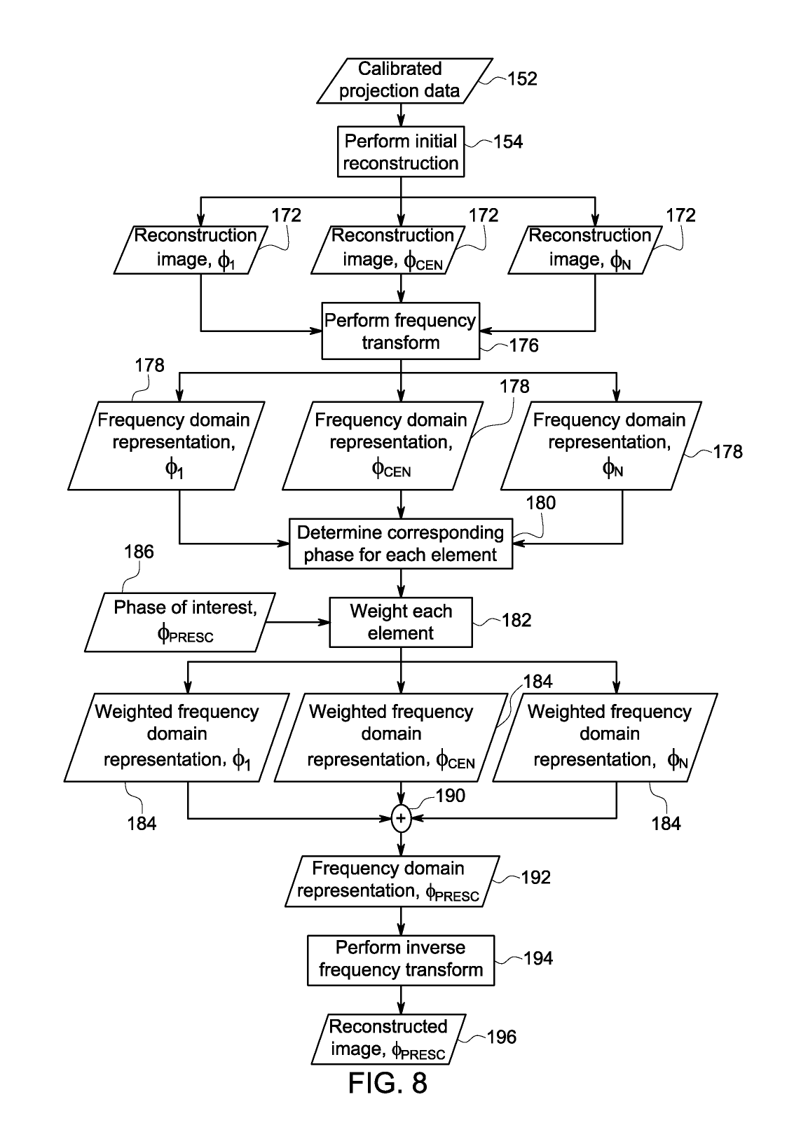

Turning to FIG. 8, an example of one implementation for generating images at arbitrary phases in accordance with the present technique is described. In accordance with this implementation, a calibrated set of projection data 152 is initially acquired using a cone-beam CT system 10, as discussed with respect to FIG. 7. The projection data 152 may be acquired using at least a partial rotation of the X-ray source 12 and detector 22 about the imaging volume (i.e., less than a full rotation, a full rotation, or more than one rotation). Further, the rotation may be axial (i.e., a circular rotation) or helical (e.g., low-pitch helical) about the imaging volume. For the purpose of the present discussion, the set of projection data 152 relate to the same imaged location or volume, but at different phases (i.e., the projection data 152 is multi-phase data retaining to the same imaged volume).

The set 152 of projection data is initially reconstructed (block 170) to generate a plurality of reconstructed images 172 at different phases (e.g., a first phase (φ₁), a centerview phase (φ_{CEN}), a N phase (φ_{N})) corresponding to phases present in the set of projection data 152. In certain embodiments, the reconstruction 170 may include one or more of the data patching or other steps discussed with respect to FIG. 7 to address issues related to data sufficiency and/or missing frequencies. For example, the reconstruction step 170 may correspond to the reconstruction steps 150 discussed with respect to FIG. 7 and the reconstructed images 172 may correspond to the reconstructed images 168 of FIG. 7. Further, in one implementation where the reconstructed images 172 are generated for phases from −70° to 70° relative to a centerview, the data patching steps do not need to be recalculated, i.e., the data patching operations discussed herein can be performed once per rotation and used with each of the reconstructed images 172. In other embodiments, the various data patching and data completeness steps may be omitted and the reconstruction step 170 may correspond to a conventional or other reconstruction approach in which data sufficiency issues (e.g., missing frequencies) are not explicitly addressed.

In the depicted example, each of the reconstructed images 172 is subjected to a frequency transformation (block 176) to generate a corresponding frequency domain representation 178. In certain implementations, the frequency transformation 176 and subsequent steps may be performed on a separate workstation than the preceding steps. For example, steps preceding the transformation 176 may be performed as part of an image acquisition while the frequency transformation and subsequent steps may be performed as part of an image review process, which may occur on a separate workstation. Each frequency domain representation 178 may be characterized by one or more frequency elements (i.e., portions or subsets of the frequency state, such as similar or identical frequency domain components or constituents). For each element of a frequency domain representation 178 a corresponding phase, φ, is determined (block 180), such as based on the central slice theorem. Each element of each frequency domain representation 178 is then weighted (block 182) to produce respective weighted frequency domain representations 184.

In one embodiment, the elements are weighted based on the difference between the determined phase for the respective element and a phase of interest, φ_{I}, 186, such as a phase specified by a reviewer. In addition, the weighting process for each element may be based upon, or limited by, a normalization condition. For example, one such normalization condition may be that the sum of the weights, over the plurality of frequency domain representations of each frequency element, should be substantially the same.

In the depicted example, the weighted frequency domain representations 184 are summed (block 190) or otherwise combined to generate a frequency domain representation at the phase of interest, φ_{I}, i.e., an arbitrary phases frequency domain representation 192 That is, the generated frequency domain representation 192 is at the phase of interest, φ_{I}, specified by the reviewer, which may or may not be present in the previous frequency domain representations 178 generated from the initial set of projection data 152.

In the depicted example, the arbitrary phase frequency representation is subjected to an inverse frequency transform 194 to generate a reconstructed image at the phase of interest, φ_{I}, i.e., an arbitrary phase reconstructed image 196. In this manner, a reviewer may generate one or more reconstructed images at various, arbitrary, phases of interest, from a single set of initial projection data 152.

Technical effects of the invention include generating multi-phase images using acquired projection data, such as low-pitch helical or axial projection data. The multi-phase images may be generated in real-time or near-real time and may be of arbitrary phases, such as phases selected or designated by a reviewer. The reconstruction process addresses data sufficiency and/or truncation issues, such as by patching in missing frequencies and/or utilizing a sector-based reconstruction where data is selected for reconstruction based on sufficiency and/or completeness.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of reconstructing multi-phase images, comprising:
accessing a set of calibrated X-ray projection data acquired over at least a partial rotation;
reconstructing a plurality of initial images at different phases based on the set of calibrated X-ray projection data;
performing a frequency transform on each initial image to generate a frequency domain representation of the respective initial image;
for each frequency element of the frequency domain representation:
determining a corresponding phase of the respective frequency element; and
weighting the frequency element based on the difference between the determined phase of the frequency element and a specified phase of interest and based on a normalization condition to produce a weighted frequency domain representation;
combining the plurality of weighted frequency domain representations to produce a frequency domain representation corresponding to a phase window centered on the selected phase of interest; and
performing an inverse frequency transform on the frequency domain representation at the specified phase of interest to produce a final image at the specified phase of interest.

2. The method of claim 1, wherein the set of calibrated X-ray projection data relate to the same imaged location or volume but at different phases.

3. The method of claim 1, wherein the at least partial rotation comprises at least a partial axial rotation or at least a partial low-pitch helical rotation.

4. The method of claim 1, wherein reconstructing the plurality of initial images comprises performing one or more data patching operations that increase the data sufficiency of the plurality of initial images.

5. The method of claim 4, wherein performing one or more data patching operations comprises performing a single data patching operation for a central phase and propagating the results of the data patching operation to proximate phases.

6. The method of claim 1, wherein determining the corresponding phase of each element is based on the central slice theorem.

7. The method of claim 1, wherein the plurality of initial images are reconstructed using an iterative reconstruction framework.

8. The method of claim 1, wherein the normalization condition comprises a condition that the sum of the weights, over the plurality of frequency domain representations of each frequency element, is substantially the same.

9. The method of claim 1, wherein combining the plurality of weighted frequency domain representations comprises summing the plurality of weighted frequency domain representations.

10. The method of claim 1, comprising specifying additional phases of interest and generating additional final images corresponding to the additional phases of interest.

11. One or more non-transitory computer-readable media, encoding one or more routines which, when executed by a processor, cause the processor to perform acts comprising:
accessing a set of calibrated X-ray projection data acquired over at least a partial rotation;
reconstructing a plurality of initial images at different phases based on the set of calibrated X-ray projection data;
performing a frequency transform on each initial image to generate a frequency domain representation of the respective initial image;
for each frequency element of the frequency domain representation:
determining a corresponding phase of the respective frequency element; and
weighting the frequency element based on the difference between the determined phase of the frequency element and a specified phase of interest and based on a normalization condition to produce a weighted frequency domain representation;
combining the plurality of weighted frequency domain representations to produce a frequency domain representation corresponding to a phase window centered on the selected phase of interest; and
performing an inverse frequency transform on the frequency domain representation at the specified phase of interest to produce a final image at the specified phase on interest.

12. The one or more non-transitory computer-readable media of claim 11, wherein the set of calibrated X-ray projection data relate to the same imaged location or volume but at different phases.

13. The one or more non-transitory computer-readable media of claim 11, wherein reconstructing the plurality of initial images comprises performing one or more data patching operations that increase the data sufficiency of the plurality of initial images.

14. The one or more non-transitory computer-readable media of claim 11, wherein determining the corresponding phase of each element is based on the central slice theorem.

15. The one or more non-transitory computer-readable media of claim 11, wherein the plurality of initial images are reconstructed using an iterative reconstruction framework.

16. The one or more non-transitory computer-readable media of claim 11, wherein the normalization condition comprises a condition that the sum of the weights, over the plurality of frequency domain representations of each frequency element, is substantially the same.

17. An image processing system, comprising:
a memory storing one or more routines; and
a processing component configured to execute the one or more routines stored in the memory, wherein the one or more routines, when executed by the processing component:
access a set of calibrated X-ray projection data acquired over at least a partial rotation;
reconstruct a plurality of initial images at different phases based on the set of calibrated X-ray projection data;
perform a frequency transform on each initial image to generate a frequency domain representation of the respective initial image;
for each frequency element of the frequency domain representation:
determine a corresponding phase of the respective frequency element; and
weight the frequency element based on the difference between the determined phase of the frequency element and a specified phase of interest and based on a normalization condition to produce a weighted frequency domain representation;
combine the plurality of weighted frequency domain representations to produce a frequency domain representation corresponding to a phase window centered on the selected phase of interest; and
perform an inverse frequency transform on the frequency domain representation at the specified phase of interest to produce a final image at the specified phase on interest.

18. The image processing system of claim 17, wherein the set of calibrated X-ray projection data relate to the same imaged location or volume but at different phases.

19. The image processing system of claim 17, wherein reconstructing the plurality of initial images comprises performing one or more data patching operations that increase the date sufficiency of the plurality of initial images.

20. The image processing system of claim 17, wherein determining the corresponding phase of each element is based on the central slice theorem.

21. The image processing system of claim 17, wherein the plurality of initial images are reconstructed using an iterative reconstruction framework.
